(19) United States
(12) Patent Application Publication
(10) Pub. No.: US 2005/0102386 A1
(43) Pub. Date: May 12, 2005

(54) Method for organizing analytic assets to improve authoring and execution using graphs

(75) Inventors: W. Nathaniel Mills III, Coventry, CT (US); Karen A. Witting, Croton-on-Hudson, NY (US)

Correspondence Address: Rafael A. Perez-Pineiro;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/694,674

(22) Filed: Oct. 28, 2003

(51) Int. Cl. G06F 15/173

(52) U.S. Cl. 709/223; 714/38; 717/124

(57) ABSTRACT

A method of organizing, managing and executing analytic assets that preserves the author's perspective (the analytic asset's boundaries) while still providing a scalable, high performance execution runtime environment. The invention includes a hierarchy of analytic assets comprising analytic Rules, Rulesets, Beans, Agents, Tests, Sessions and Runtimes, each encapsulating analytic functions that are uniquely identified and that have clear boundaries. The present invention also manages the Runtime to avoid conflicts and to optimize navigation based on evaluation of weights connecting tests.

### CROSS-REFERENCE

The present application is related to pending U.S. application Ser. Nos. 10/326,375; 10/326,400; and 10/326,380, which are owned by IBM Corp., the assignee of the present application. The disclosures of those applications are incorporated herein by reference.

### BACKGROUND OF THE INVENTION

1. Field of the Invention

The invention generally relates to the data processing field. More specifically, the invention relates to the field of systems management.

2. Description of the Related Art

Systems management involves analysis of system operational data to determine whether a problem (e.g., the system is not behaving as designed or desired) exists or is projected to occur based on trends. Sensors typically monitor the system to gather such operational data and various reasoning techniques are applied to determine problem symptoms and/or root causes of failures. These reasoning techniques often embody analytic assets such as externalized rules, tests, or procedures that are applied manually or automatically to assess the health and safety of the system. These analytic assets are typically authored by domain experts that understand how the system is expected and desired to operate. The domain experts can recognize developing or existing problems based on behaviors reflected by data gathered from the system. The analytic assets are then presented to a system management system's (SMS′) runtime framework for execution. The manner in which these analytic assets are organized for execution in the SMS impacts the SMS performance and utility.

Often the individual analytic assets are combined into an analytic runtime that is executed by the SMS. In cases where analytic assets are independent and execution is linear, for example by evaluating them as a list, the assets can then be maintained in the list independent of the runtime. However this approach is not practical because analytic assets are sometimes not independent, and the approach would be often inefficient as there is little control over the execution of analytic assets—they are analyzed in order until a solution is found. To address this inefficiency, analytic assets are often organized in a directed acyclic graph to limit which analytic assets are evaluated by the SMS by following a particular path of navigation relevant to the problem being diagnosed. Once combined in a graph, the analytic assets can no longer be maintained independent of this runtime. Examples include decision trees, bayesian networks, pattern matching or neural networks. Once organized in a graph, it is difficult to preserve the original analytic asset authors' perspective of the purpose or intent of their work as the boundaries defining the original analytic asset have been lost when the asset was merged into the analytic runtime graph. This approach causes maintenance of analytic assets (e.g., adding new, changing or deleting existing assets) to be performed on the entire analytic runtime graph, raising the level of complexity and introducing potential unexpected consequences.

The present invention solves the problem of the prior art by providing a method to enable the authoring of analytic assets such that they can be combined in an analytic runtime graph, while retaining their original boundaries. The present invention thus enables the authors to make modifications without the requirements of switching paradigms and/or working with the entire analytic runtime. This method also promotes collaboration during the authoring process, promotes analytic asset reuse, and provides control over performance and optimized analytic runtime graph navigation.

### SUMMARY OF THE INVENTION

In view of the foregoing, an embodiment of the present invention provides a method of organizing, managing and executing analytic assets that preserves the author's perspective (e.g., the analytic asset's boundaries) while still providing a scalable, high performance execution runtime environment. The Invention describes a hierarchy of analytic assets comprising analytic Rules, Rulesets, Beans, Agents, Tests, Sessions and Runtimes that each encapsulates analytic function, that are uniquely identified, and that have clear boundaries. SMS′ analyze a system's state by executing an analytic Runtime by optionally providing data to be analyzed (Analysis Data) and by specifying a type of analysis to be performed (Analysis Type). The invention manages introduction of new analytic assets to the Runtime to ensure they don't introduce execution problems like circularity (not allowed in acyclic graphs). An important benefit of the invention is the synergy produced by merging analytic assets into the Runtime by matching common components and adjusting the Runtime graph navigation weights (if present).

Navigation weights are used during path selection through the resulting graph of analytic assets in the Runtime, and include a function of any combination of material costs, labor costs, engineering feedback regarding system and/or component operation, and historic feedback of actual system and/or component operation. For example, in a situation where these factors are deemed to be of equal importance in calculating the weight, the values may simply be added together. This invention also provides for functions that allow different weight factors to carry more influence than others (e.g., in situations where materials are expensive relative to labor, the material costs may be multiplied by a factor to increase their influence). Values contributing to the weight calculation may also be normalized to a value between 0 and 1, inclusive and optionally have factors applied to increase or decrease their relative contribution to the weight calculation.

These and other aspects of the invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a first chart illustrating one method of the present invention;

FIG. 2 is a second chart illustrating a second method of the present invention; and

FIG. 3 illustrates a representative Hardware Environment for practicing the present invention.

### DETAILED DESCRIPTION OF PREFERRED EMBODIMENTS OF THE INVENTION

Referring now to the drawings, a preferred embodiment of the present invention will now be described. A person of ordinary skill in the art will understand that the invention is not limited in any manner by the disclosed embodiments or the drawings used in this application to describe the same.

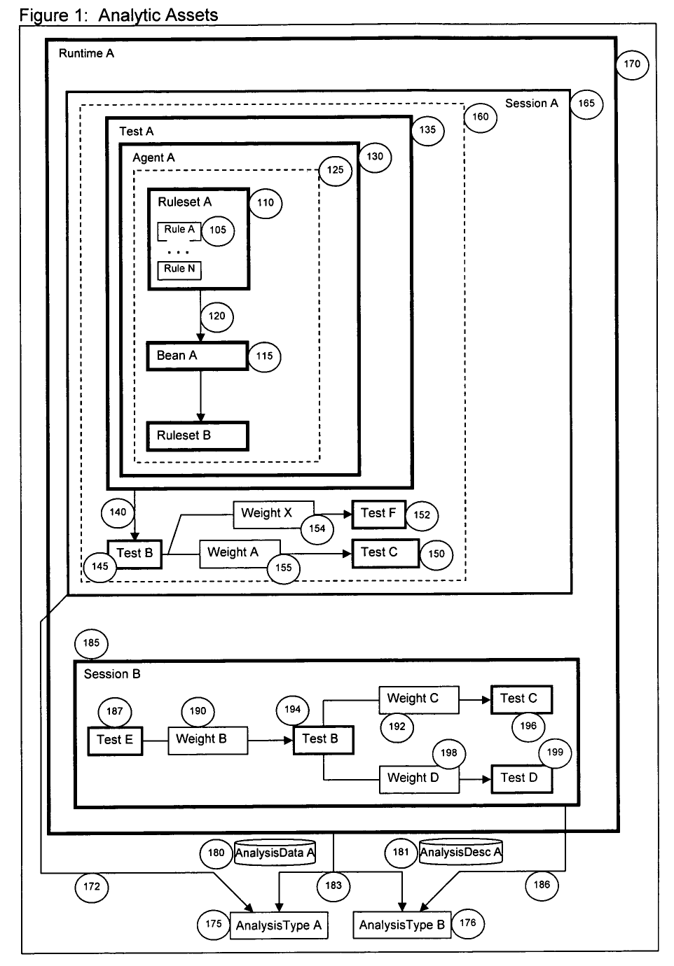

This Invention proposes a hierarchical organization for analytic assets. The lowest level of the hierarchy includes individual collections of one or more Rules (e.g., Rule A 105 in FIG. 1) called a Ruleset (e.g., Ruleset A 110 in FIG. 1), or specialized empirical or analytic reasoning software or machinery configured for specific analytic purposes called Beans (e.g., Bean A 115 in FIG. 1). One or more Rulesets and/or Beans may be connected (e.g., see connection arrow 120 in FIG. 1) creating a directed graph (e.g., see 125 in FIG. 1) forming a particular workflow to produce and/or analyze data. These graphs may be called Agents (e.g., see Agent A 130 in FIG. 1). Agents form executable components that perform some or all of these tasks: take in data, analyze it, produce, store, and/or return results. To allow a particular Agent to be applied in different contexts, a reference to the Agent is provided with a unique identifier, referred herein as a Test (e.g., see Test A 135 in FIG. 1).

A Test may be viewed as a wrapper for an agent. In one application of the present invention, a Test may simply be a computerized test run on an automotive part to determine a problem with the car containing the part.

An Agent may be defined as a procedure for performing analysis. An Agent may be embodied in the form of a script. The Agent may include beans (e.g., functions) or rulesets (e.g., scripts of rules).

Different Tests may reference the same Agent. Tests may then be organized in a graph optionally having weighted connections used to prioritize navigation. In FIG. 1, Test A 135 is connected using an unweighted connection 140 to Test B 145. Test B uses a weighted connection 155 to connect to Test C 150. A directed, acyclic graph of Tests (e.g., see 160 in FIG. 1) may be called a Session (e.g., see Session A 165 in FIG. 1). Finally, the Sessions may be combined (merged) into a single directed, acyclic graph known as a Runtime (e.g., see Runtime A 170 in FIG. 1) which can be executed by the SMS. Thus, one goal of the present invention is to produce the following hierarchy of Analytic Assets: Runtimes including Sessions, Sessions including Tests, Tests including Agents, Agents including one or more Rulesets and/or Beans, and Rulesets including one or more Rules.

Authoring analytic assets may involve developing and maintaining everything in this hierarchy below the Runtime (e.g., Sessions, Tests, Agents, Beans and/or Rulesets), and later merging Sessions into select Runtimes. The SMS executes a Runtime analytic asset. The authoring environment may allow execution of authored analytic assets for testing and debugging purposes. Sessions are merged into a Runtime at which point the Session can be checked for any incompatibility with the Runtime (e.g., the new Session results in a potential circular execution path in the Runtime due to the order the Tests are referenced within the Session's graph). These incompatibilities are able to be noticed using standard graph analysis known to those familiar with the art.

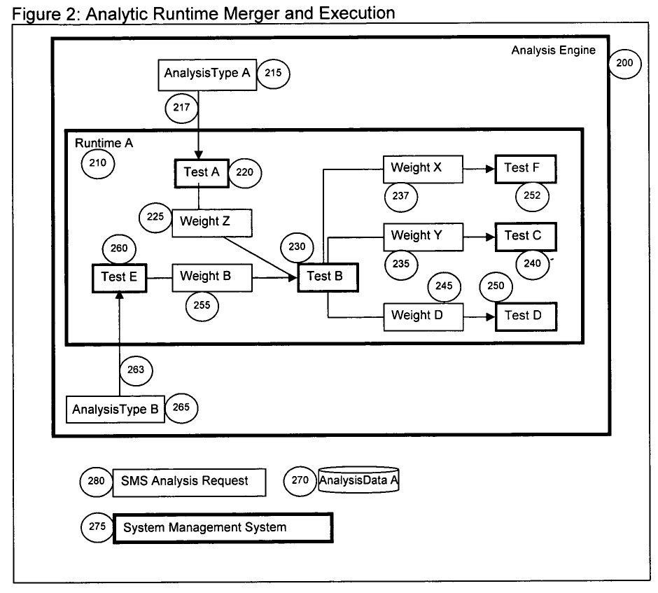

In addition to the analytic asset hierarchy, this Invention references the concepts of Analysis Type (e.g., see AnalysisType A 175 in FIG. 1) and Analysis Data (e.g., see AnalysisData A 180 in FIG. 1). Analysis Data may be defined as a container that holds data and that is submitted for a particular type of analysis (Analysis Type). Sessions may be associated with one or more Analysis Types. In FIG. 1, Session A 165 is associated 172 with Analysis Type A 175, and Session B 185 is associated 186 with Analysis Type B 176. When Sessions are added into a Runtime, the Runtime becomes associated with the Session's Analysis Type, if present. In FIG. 2, Runtime A 210 is associated 217 with Analysis Type A 215, and associated 263 with Analysis Type B 265. The Analysis Type provides an entry point into the Runtime graph for execution of analysis (e.g., a starting point for navigation of the Runtime graph). In FIG. 1, Session A 165 is associated 172 with Analysis Type A 175, and Session B 185 is associated 186 with Analysis Type B 176. FIG. 1 also shows Analysis Data A 180 which may be used during authoring to test execution of analytic assets.

Because this invention organizes the analytic assets in a hierarchy, the authoring environment may provide query facilities to review descriptions (e.g., see AnalysisDesc A 181) of the purpose, function and intent of each analytic asset to see if it makes sense for use in (e.g., to be referenced by) the analytic asset currently being created or maintained. Because each analytic asset is uniquely identified, and can be referenced my multiple parents in the analytic asset hierarchy, the present invention promotes analytic asset reuse by allowing authors to search for an existing function before creating a new analytic asset.

Each analytic asset encapsulates its function allowing the author to focus on the analysis it performs, and not on the analytic asset's composition. Improvements in efficiency, error checking or other non-function affecting alterations is possible without introducing adverse consequences to the higher order analytic assets that reference them. Even new functions can be introduced without concern for impact on higher order analytic assets. If a function needs to be altered, the author of the asset would create a copy of the existing analytic asset and make the changes in the copy, thus producing a new analytic asset that can be added as a new or replacement component to other higher order analytic assets. Note, when introducing an analytic component as a replacement, the author should consider if it causes a change in the behavior of the higher order analytic asset, and whether or not this is desired behavior. The encapsulation of functions at each level of the analytic asset hierarchy may reduce the author's task to, at most, considering the effects on individual Sessions. The authors do not need to consider the effects on the Runtime.

The present invention promotes synergy of analytic assets because it allows reuse of analytic assets. Two Sessions authored independently may reference the same Tests, allowing them to become joined in the Runtime. The work of different authors can be combined without their explicit collaboration, allowing the Runtime to benefit from the independent work and find the best execution path. In FIG. 1, Session A 165 and Session B 185 both reference Test B 145 or 194. In the illustrated example, when these Sessions are merged in the same Runtime, the weighted connection A 155 in Session A 165 from Test B 145 to Test C 150 is combined with the weighted connection C 192. Test B 145 would also have the weighted connection X 154 to Test F 152, as well as the weighted connection D 198 to Test D 199. Test B 145 has a weighted connection B 190 from Test E 187, as well as the unweighted connection 140 from Test A 135.

A simple example of combining weights on connections would be to add them together. This invention also encompasses more elaborate weight combination functions that take into consideration relative weights (e.g., percentage of the weight being added to sum of the weights on connections originating from the Test), or historic weights (e.g., taking into consideration the number of times the connection has been navigated to allow weights with more history (or less history depending on customer desires) to have more influence when combined with weights having less history (or, respectively, more history).

When Sessions are added to a Runtime, the Runtime may be searched to see if a Test referenced in the Session has already been added to the Runtime (e.g., by an author previously adding a different Session that contained a reference to the same Test). If none exists, the Test may be added, otherwise, the existing Test is selected for updating. The added or selected Test is examined to see if the connections in the Session cause a circular reference. If so, the Session may not be allowed to be added to the Runtime, and previous updates to the Runtime related to this Session are backed out. If there are no problems, connections from the newly added or selected Test may be created or updated for the next level of Tests in the Session being added to the Runtime. In situations where there is a conflict when adding a Session to a Runtime, the author has the flexibility to create a new Test that references the same Agent (preserving the function, but avoiding conflict with the existing Test's use in the Runtime) and resubmitting the Session referencing the new Test.

FIG. 2 illustrates the merger of Session A and Session B from FIG. 1. In the illustrated example, Runtime A 210 is associated with two Analysis Types: Test A 220 is associated 217 with Analysis Type A 215, and Test E 260 is associated 263 with Analysis Type B 265. Test A 220, that previously had an unweighted connection (see FIG. 1 140) now has a weighted connection Z to Test B 230. The weight for connection Z would be the value representing the lowest choice for execution supported by the Runtime (e.g., a null or zero weight).

The Analysis Engine 200 evaluates possible connections leaving from a Test to determine the next Test to be evaluated and unweighted connections would be selected after having evaluated all weighted connections. Test E 260 retains its weighted connection B 255 to Test B. However, a new weighted connection Y 235 has been created between Test B 230 and Test C 240 reflecting the combination of weighted connection A 155 and weighted connection C 192. In one embodiment, combining an unweighted connection and a weighted connection yields the same weight as the weighted connection.

The original weighted connections A 155 and C 192 are replaced by this new combined weighted connection Y 235. The other weighted connections D 245 to Test D 250, and X 237 to Test F 252 remain connected from Test B 230. So, the affect of merging both Session A and B into a common runtime is there are two types of analysis that can be performed, starting at different locations in the Runtime, unweighted connections are adjusted to be the lowest priority connection from a Test, overlapping weighted connections are combined and replaced by a single connection, and common Tests in both Sessions reflect all connections.

Test A 220 and Test E 260 may be considered entry points into the Runtime A 210 because they represent the start of execution, depending on which Analysis Type is specified by the System Management System 275 in its SMS Analysis Request 280, submitted for execution to the Analysis Engine 200. The SMS Analysis Request 280 may also specify initial data for analysis contained in Analysis Data A 270, and at completion of the analysis, the result will reside in Analysis Data A 270.

When the connections between Tests in a Session carry weights, these weights are combined with the existing weights on similarly connected Tests within the Runtime. The weights are used to optimize navigation within the Runtime by providing a distinguishing characteristic of the potential paths to be followed during execution. The weights may comprise factors drawn from experience or data used to assess a benefit of selecting one path over others. Weight composition may include, but are not limited to material and labor costs to perform the analysis, a subjective rating by engineering or others regarding the likelihood the analysis will prove beneficial, or a historic rating of the success of past attempts at performing the analysis along this connection.

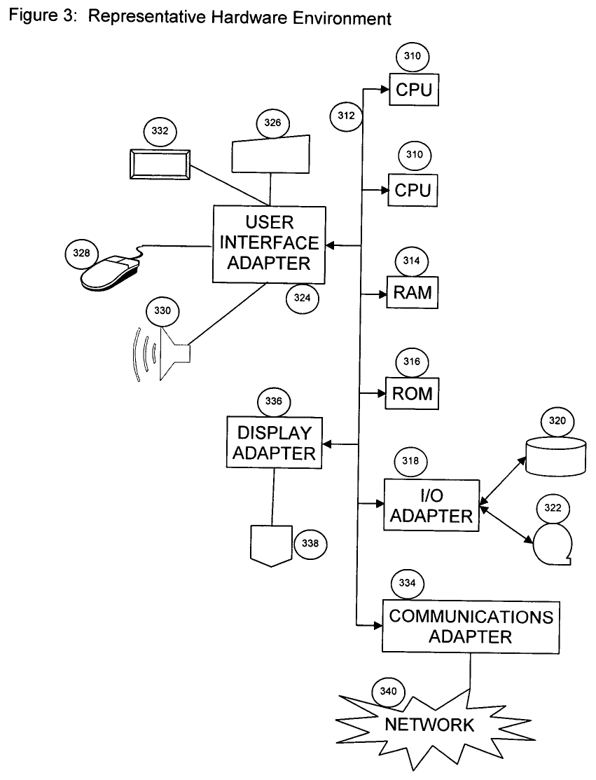

A representative hardware environment (e.g., computer system) for practicing the present invention is depicted in FIG. 3, which illustrates a typical hardware configuration of an information handling/computer system in accordance with the present invention, having at least one processor or central processing unit (CPU) 310. The CPUs 310 are interconnected via system bus 312 to random access memory (RAM) 314, read-only memory (ROM) 316, an input/output (I/O) adapter 318 for connecting peripheral devices, such as disk units 320 and tape drives 322, to bus 312, user interface adapter 324 for connecting keyboard 326, mouse 328, speaker 330, microphone 332, and/or other user interface devices such as a touch screen device (not shown) to bus 312, communication adapter 334 for connecting the information handling system to a data processing network 340, and display adapter 336 for connecting bus 312 to display device 338. A program storage device readable by the disk or tape units is used to load the instructions, which operate the invention, which is loaded onto the computer system.

While the invention has been described in terms of a single embodiment, those skilled in the art will recognize that the invention can be practiced with modification within the spirit and scope of the appended claims. For example, while the description above may have referenced the application of the present invention to the field of automobile diagnostics, the present invention is applicable to any kind of system or procedure where testing is involved.

Further, it is noted that, Applicants' intent is to encompass equivalents of all claim elements, even if amended later during prosecution.

1. A method for building a session, comprising:
receiving a first session;
creating a first runtime of the first session;
receiving a second session; and
merging the second session with the first runtime of the first session to create a second runtime.

2. The method of claim 1, further comprising:
receiving an updated second session; and
merging the updated second session with the first runtime of the first session to create a third runtime.

3. The method of claim 1, wherein the merging step comprises joining the first and second sessions at tests common to both sessions.

4. The method of claim 1, wherein the merging step comprises computing weights on navigation paths in the second runtime to optimize navigation during execution of the second runtime.

5. The method of claim 1, wherein the step of creating a first runtime comprises establishing first weights associated with the navigation of the first session.

6. The method of claim 5, wherein the step of merging the first runtime with the second session comprises combining the first weights with second weights associated with the navigation of the second session.

7. The method of claim 1, further comprising the step of selecting a best route of navigation of the second runtime based on weights associated with tests in the second runtime.

8. A method for building a session, comprising:
receiving a first runtime of a first session;
authoring a second session; and
merging the second session with the first runtime of the first session to create a second runtime.

9. The method of claim 8, wherein the merging step comprises joining the first and second sessions at tests common to both sessions.

10. The method of claim 8, wherein the merging step comprises computing weights on navigation paths in the second runtime to optimize navigation during execution of the second runtime.

11. The method of claim 8, wherein the step of merging the first runtime with the second session comprises combining first weights associated with the navigation of the first session with second weights associated with the navigation of the second session.

12. The method of claim 8, further comprising the step of selecting a best route of navigation of the second runtime based on weights associated with tests in the second runtime.

13. The method of claim 1, further comprising associating types of analysis with different entry points in the second runtime.

14. The method of claim 8, further comprising associating types of analysis with different entry points in the runtime

15. The method of claim 8, wherein the step of authoring the second session comprises organizing analytic assets in a hierarchy.

16. The method of claim 8, wherein the step of authoring the second session comprises:
assigning a unique identifier to the second session; and
creating a directed acyclic graph of at least one test.

17. The method of claim 16, wherein the step of creating a graph comprises assigning navigation weights between at least two tests.

18. The method of claim 17, wherein the weights are assigned according to one or more of the following factors:
material costs;
labor costs;
engineering feedback regarding system or component operation; and
historic feedback of actual system or component operation.

19. The method of claim 16, further comprising:
authoring the at least one test to include a unique identifier and an agent.

20. The method of claim 19, further comprising:
authoring the agent to include a unique identifier and a graph of beans.

21. The method of claim 19, further comprising:
authoring the agent to include a unique identifier and a graph of rulesets defining an analytic workflow.

22. The method of claim 20, wherein at least one of said beans comprises a unique identifier, and software or machinery that is configured to perform data analysis or to process data for analysis.

23. The method of claim 21, further comprising:
authoring the ruleset to include a unique identifier, a collection of rules able to be executed to perform analysis, and supporting statements that define access to data in support of the analysis.

24. The method of claim 21, wherein at least one of said rules comprises an optional unique identifier, and a statement to enable analysis to be performed.

25. The method of claim 8, wherein the step of authoring the second session incudes associating the second session with one or more analysis types defining the kind of analysis performed by the second session.

26. The method of claim 1, further comprising associating the second runtime with one or more analysis data and analysis types defined by the first and second sessions.

27. The method of claim 15, further comprising querying said analytic assets to understand their intent, purpose and analytic function to promote reuse when authoring other analytic assets.
